(19) United States
(12) Patent Application Publication
(10) Pub. No.: US 2012/0311236 A1
(43) Pub. Date: Dec. 6, 2012

(54) MEMORY SYSTEM, DATA CONTROL METHOD, AND DATA CONTROLLER

(75) Inventor: Gen OHSHIMA, Tokyo (JP)

(73) Assignee: Kabushiki Kaisha Toshiba, Tokyo (JP)

(21) Appl. No.: 13/424,351

(22) Filed: Mar. 19, 2012

(30) Foreign Application Priority Data
May 31, 2011 (JP) 2011-122753

(51) Int. Cl. G06F 12/02

(52) U.S. Cl. 711/103; 711/E12.008

(57) ABSTRACT

According to one embodiment, a memory system includes: a non-volatile memory; a storage configured to store therein data temporarily; a notifying module configured to notify a host of data transfer permission with a specified amount of data to be written in the storage; a transfer module configured to transfer data transferred from the host according to the data transfer permission to the storage, and to transfer the data stored in the storage to be written to the non-volatile memory; and a controller configured to inhibit notification of the data transfer permission by the notifying module until transfer of the data to the non-volatile memory by the transfer module is completed after an amount of data necessary to be written in the non-volatile memory is stored in the storage.

### CROSS-REFERENCE TO RELATED APPLICATIONS

This application is based upon and claims the benefit of priority from Japanese Patent Application No. 2011-122753, filed May 31, 2011, the entire contents of which are incorporated herein by reference.

### FIELD

An embodiment described herein relates generally to a memory system, a data control method, and a data controller.

### BACKGROUND

A memory system referred to as a solid state drive (SSD) has been available. The SSD includes a flash memory that is a semiconductor memory. In recent years, there has been an increasing trend of an SSD being used as a memory system built in a personal computer (PC) in place of an HDD.

As an interface to connect these memory systems, serial attached SCSI (SAS), serial advanced technology attachment (SATA), fiber channel (FC), and the like have been proposed. SATA is used for applications that place emphasis on low price such as personal use. SAS is used for applications that require high performance and high reliability such as servers. FC is a technology used for a storage network, and uses SCSI commands similarly to SAS in place of IP on a network.

For example, SAS, FC, and such used as an interface improve reliability because data is sent after a status of a connection destination is checked. More specifically, an SSD using any one of these interfaces is committed to securing a certain transferable amount of data to a host, thereby reliably transferring data.

An SSD has a plurality of channels internally, and carries out reading from or writing to non-volatile memories on the respective channels. In the SSD, writing operation can be carried out in an interleaved manner. In other words, the SSD can carry out writing to the non-volatile memories on multiple channels simultaneously. This allows high-speed writing to be realized.

However, in an SSD using conventional technologies, when writing is carried out simultaneously on multiple channels with a transferable amount of data committed to a host, a controller inside the SSD carries out a process for the writing in priority. There is therefore a possibility that the data transferred from the host cannot be processed properly and a freeze-up may occur in a state of a bus being connected. If these happen, other devices sharing the bus cannot use the bus either, deteriorating usage efficiency of the bus.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram schematically illustrating a configuration example of a semiconductor disk device according to an embodiment;

FIG. 2 is an exemplary block diagram schematically illustrating a software configuration of a first MPU and a second MPU in the embodiment;

FIG. 3 is an exemplary timing chart illustrating transfer timings of sequential write in the semiconductor disk device in the embodiment;

FIG. 4 is an exemplary timing chart illustrating transfer timings of random write in the semiconductor disk device in the embodiment;

FIG. 5 is an exemplary flowchart illustrating a procedure of a process for carrying out all channel simultaneous writing in the second MPU in the embodiment; and

FIG. 6 is an exemplary flowchart illustrating a procedure of a process for executing a write command in the first MPU in the embodiment.

### DETAILED DESCRIPTION

In general, according to one embodiment, a memory system comprises a non-volatile memory, a storage, a transfer module, and a controller. The storage is configured to store therein data temporarily. The notifying module is configured to notify a host of data transfer permission with a specified amount of data to be written in the storage. The transfer module is configured to transfer data transferred from the host according to the data transfer permission to the storage, and to transfer the data stored in the storage to be written to the non-volatile memory. The controller is configured to inhibit notification of the data transfer permission by the notifying module until transfer of the data to the non-volatile memory by the transfer module is completed after an amount of data necessary to be written in the non-volatile memory is stored in the storage.

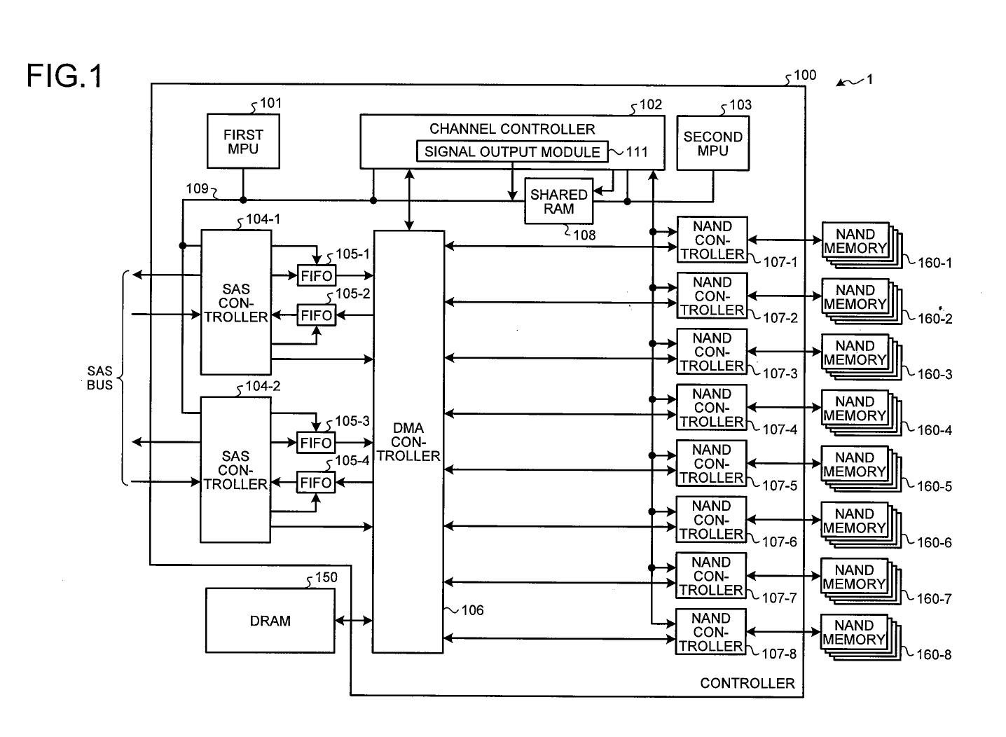

One embodiment will be described in detail hereinafter with reference to some drawings. A semiconductor disk device as a memory system according to the embodiment will be described. FIG. 1 is a block diagram schematically illustrating a configuration example of a semiconductor disk device 1 according to an embodiment. As illustrated in FIG. 1, the semiconductor disk device 1 comprises a semiconductor disk controller 100, a DRAM 150, and eight pieces of NAND memories 160-1 to 160-8.

The DRAM 150 is a storage that stores therein data temporarily. The DRAM 150 stores therein temporarily the data transferred from a host. The DRAM 150 further stores therein temporarily the data read out from the NAND memories 160-1 to 160-8.

The NAND memories 160-1 to 160-8 store therein data used by the host (hereinafter, referred to as user data) and such. While eight pieces of the NAND memories 160-1 to 160-8 are exemplified in the present embodiment, the number of memories is not restricted thereto.

The semiconductor disk controller 100 comprises a first MPU 101, a channel controller 102, a second MPU 103, SAS controllers 104-1 and 104-2, FIFO buffers 105-1 to 105-4, a direct memory access (DMA) controller 106, NAND memory controllers 107-1 to 107-8, and a shared RAM 108.

The semiconductor disk controller 100 further comprises SAS interfaces in two ports. The semiconductor disk controller 100 sends and receives data to and from the host via the respective ports.

Although SAS is a point-to-point connection in full-duplex communication, connecting a SAS expander as a relay allows the connection of a plurality of devices to a single host. Accordingly, a bus can be used, shared with other devices.

The first MPU 101 controls sending and receiving of data to and from the host connected via the bus. For example, when executing a write command, the first MPU 101 allocates an area necessary to store data in the DRAM 150 and notifies the host of an amount of data transfer indicative of the allocated area according to a Transfer_Ready frame format. While the present embodiment is exemplified with SAS, the same can be applied to the case with FC.

When the host needs to store data to the semiconductor disk device 1, the host issues a write command to the semiconductor disk device 1. When a write command is issued, the SAS controllers 104-1 and 104-2 receive the write command. The first MPU 101 then receives the write command through a processor bus 109 and executes the write command.

The first MPU 101 then, along with the execution of the write command, creates a Transfer_Ready frame and sends the frame to the host to receive user data from the host. In practice, the first MPU 101 does not notify of the Transfer_Ready frame by itself, but realizes the notification by requesting the SAS controllers 104-1 and 104-2 to issue the Transfer_Ready frame.

The FIFO buffers 105-1 to 105-4 are buffers that absorb a difference in speed between a data transfer speed by the SAS controllers 104-1 and 104-2 and a data transfer speed by the DMA controller 106. The SAS interface allows simultaneous bidirectional communication on each port. Accordingly, the FIFO buffers 105-1 to 105-4 are separately provided for sending lines and for receiving lines.

The SAS controllers 104-1 and 104-2 are controllers that control data transfers with the SAS interface. The SAS controllers 104-1 and 104-2 are further connected with the DMA controller 106 via the FIFO buffers 105-1 to 105-4.

The SAS controllers 104-1 and 104-2 create a Transfer_Ready frame and send the frame to the host in response to a request from the first MPU 101. A Transfer_Ready frame is information indicative of data transfer permission for the host, and contains information specifying an amount of data transfer from the host to the semiconductor disk device 1.

When a data storage space necessary for a single write command cannot be allocated on the DRAM 150 at one time, the first MPU 101 divides a data transfer request to the host into multiple requests. In this case, a procedure of sending a Transfer_Ready frame to the host and receiving data from the host is repeated a number of times. In the specifications of SAS, when the semiconductor disk device 1 sends a Transfer_Ready frame as a response to a write command from the host and a different write command is received before finishing the receiving of data corresponding to the frame, the semiconductor disk device 1 can respond with another Transfer_Ready frame to the host as long as the command is different.

The host transfers data of an amount of data transfer contained in the Transfer_Ready frame to the semiconductor disk device 1. When the SAS controllers 104-1 and 104-2 receive the data transferred from the host, the DMA controller 106 stores the data to the DRAM 150 at an address specified by the first MPU 101. At that time, the SAS controllers 104-1 and 104-2 divide the received data into a minimum write unit of the NAND memories 160-1 to 160-8. The SAS controllers 104-1 and 104-2 then issue a write command to the channel controller 102 to write to the NAND memories 160-1 to 160-8.

The channel controller 102 is a controller that controls data transfers to and from the NAND memories 160-1 to 160-8. For example, when the SAS controllers 104-1 and 104-2 issue a write command, the channel controller 102 controls to write the data stored in the DRAM 150 to the NAND memories 160-1 to 160-8.

The DMA controller 106 is a controller that controls DMA data transfers between the SAS interface and the DRAM 150 and between the DRAM 150 and the NAND memories 160-1 to 160-8 in response to a request from the channel controller 102 without an intervention of an MPU (for example, the first MPU 101).

The DMA controller 106 transfers user data transferred from the host according to a Transfer_Ready frame to the DRAM 150. Furthermore, the DMA controller 106 transfers data stored in the DRAM 150 to write to the NAND memories 160-1 to 160-8 with all channels synchronized. This transfer is carried out when the data transferred from the host is stored in the DRAM 150 by a writable amount of data stored in the shared RAM 108. While simultaneous writing is carried out on all channels in the present embodiment, a plurality of channels only, but not all channels, needs to be synchronized.

The NAND memory controllers 107-1 to 107-8 are controllers that control writing of data to or reading of data from the NAND memories 160-1 to 160-8 in response to a request from the channel controller 102.

Furthermore, between the DMA controller 106 and the NAND memory controllers 107-1 to 107-8, FIFO buffers not illustrated are provided for respective channels. The FIFO buffer provided for each channel has a minimum capacity capable of storing data read out from the respective NAND memories 160-1 to 160-8 when a read command is issued. However, with a write command, simultaneous writing to a plurality of areas in the NAND memories is carried out to improve a writing speed. Therefore, the amount of data to write when a write command is executed is larger than the amount of data to read when a read command is executed, and thus it cannot be absorbed by the FIFO buffers. Accordingly, in the semiconductor disk device 1 in the present embodiment, a later described process is carried out when all channel simultaneous writing is carried out.

In a SATA interface that can hold host transfer and a PCIe interface that controls transfer itself on a semiconductor disk device side, it is possible to stop sending of data from the host from the semiconductor disk device side. However, in a SAS interface and a fiber channel (FC) interface in which communication is carried out committing in advance a transferable amount of data to a host, it is difficult to stop transferring from the host halfway which is already committed to. Consequently, when a conventional SAS interface or an FC interface is used, the following problems may arise.

The timings of sequential in a semiconductor disk device with a conventional SAS interface will be explained. In the conventional semiconductor disk device, when a write command is received from a host, one or more Transfer_Ready frames are output corresponding to a buffer space allocated in a DRAM to notify the host of specification of a transferable amount of data. The host then transfers data by the notified amount of data to the semiconductor disk device. Conventionally, such notification of Transfer_Ready frames and transfer of corresponding data are repeatedly carried out.

The semiconductor disk device having received a plurality of sequential write commands permits the host to send data by the amount that a buffer provided on the DRAM can hold. Accordingly, the conventional semiconductor disk device should be able to store the received data to the buffer basically. However, when the DMA controller starts reading of user data from the DRAM to simultaneously write to the NAND memories after all channels are synchronized, it may receive user data from the SAS interface. In this case, in the DMA controller, a process of reading out user data from the DRAM and a process of writing user data from the SAS interface to the DRAM conflict with each other. At that time, the DMA controller carries out the process of reading out user data from the DRAM in priority. Consequently, transfer of user data from the host to the semiconductor disk device stops. Therefore, when receiving user data corresponding to a Transfer_Ready frame, there arises a non-transfer period in which the user data is not transferred to the SAS interface at the timing of the DMA controller transferring user data to the NAND controllers.

More specifically, at the timing of writing to the NAND memories being completed, the buffer space for the completed writing is released from the DRAM. The DRAM thus becomes available for data to be written, so that the SAS controller sends a Transfer_Ready frame and then receives user data corresponding to the frame. This timing is the exact timing at which the DMA controller starts the subsequent channel synchronous transfer. Therefore, the processes conflict with each other in the DMA controller, and thus a non-transfer period inevitably arises. Even in the non-transfer period, the connection between the host and the semiconductor disk device is continued. Accordingly, in the conventional semiconductor disk device, there occurs a freeze-up phenomenon in which the connection is continued even though the data transfer is not being carried out. At that time, other devices sharing the bus cannot use the bus, so that the usage efficiency of the bus is deteriorated, and thus the performance of the whole system is deteriorated.

In contrast, in the present embodiment, the semiconductor disk device 1 with a SAS interface applied carries out such a later described control that a non-transfer period does not arise.

Referring back to FIG. 1, the second MPU 103 controls sending and receiving of data to and from the NAND memories 160-1 to 160-8. The second MPU 103 provides physical addresses for all channels of the NAND memories 160-1 to 160-8 to the channel controller 102.

The channel controller 102 assigns data to write by a write command to the physical addresses provided. While it is described in the present embodiment that the second MPU 103 provides physical addresses to the channel controller 102 each time simultaneous writing on all channels at one time is carried out, it is only one embodiment.

The timing of the second MPU 103 providing physical addresses will be explained. The second MPU 103 periodically monitors an operation status of the channel controller 102. When a start of the channel controller 102 controlling simultaneous writing with all channels being synchronized is detected, the second MPU 103 provides new physical addresses to the channel controller 102 again.

The channel controller 102 further comprises a signal output module 111. The channel controller 102 stores in the DRAM 150 an amount of data necessary to write to the NAND memories 160-1 to 160-8 with all channels synchronized in order to carryout all channel simultaneous writing. Thereafter, the channel controller 102 inhibits notification of Transfer_Ready frame by the SAS controllers 104-1 and 104-2 until the DMA controller 106 completes data transfer to the NAND memories 160-1 to 160-8.

To inhibit the notification, the signal output module 111 outputs a transfer detecting signal indicative of whether the DMA controller 106 is carrying out data transfer to the NAND memories 160-1 to 160-8. For example, when a start of the channel controller 102 transferring for simultaneous writing with all channels synchronized is detected, the signal output module 111 outputs a signal of 1 indicative of data transfer being carried out, and switches the signal to 0 when a completion of data transfer is detected.

Furthermore, when providing physical addresses to the channel controller 102, the second MPU 103 does not assign data to write on a channel where a non-writable defect is present among the NAND memories 160-1 to 160-8.

When providing new physical addresses to the channel controller 102, the second MPU 103 simultaneously sets an amount of data to the shared RAM 108. The amount of data set is an amount of data that is simultaneously writable to the NAND memories 160-1 to 160-8 at one time with all channels synchronized. When determining the amount of data, the second MPU 103 takes into account a non-writable channel due to the presence of defects. Consequently, there is a possibility of the simultaneously writable amount of data set to the shared RAM 108 being varied each time.

The shared RAM 108 is a dual-port RAM that is referable from the first MPU 101 and the second MPU 103, and stores therein an amount of data simultaneously writable at one time with all channels synchronized.

When requesting to send a Transfer_Ready frame to receive user data from the host, the first MPU 101 in the present embodiment refers to the shared RAM 108. The first MPU 101 then requests the SAS controllers 104-1 and 104-2 to send a Transfer_Ready frame only when the amount of data stored in the shared RAM 108 is not 0.

The first MPU 101 subtracts a value corresponding to the requested amount of data from the amount of data stored in the shared RAM 108 each time it requests the sending of a Transfer_Ready frame. When the amount of data stored in the shared RAM 108 is reduced to 0, the first MPU 101 can no longer perform the subsequent request of sending a Transfer_Ready frame.

Conventionally, a transfer amount of data contained in a Transfer_Ready frame is limited to either the transfer amount of data requested by a command or a buffer capacity available on the DRAM, whichever is smaller. In such conventional technology, because the receiving of data is continued as long as the buffer capacity is available on the DRAM, there is a possibility of a simultaneous writing to the NAND memories with channels synchronized and a data receiving process in the semiconductor disk device conflicting with each other.

Accordingly, in the present embodiment, in addition to these conditions (a transfer amount of data, an available buffer capacity on the DRAM 150), a writable amount of data stored in the shared RAM 108 is added to the determining conditions. The first MPU 101 sets the smallest amount of data among these three conditions as an amount of data transfer contained in a Transfer_Ready frame. Furthermore, when any one of these three conditions is of 0 byte, the first MPU 101 controls not to commit transfer.

When the first MPU 101 requests the SAS controllers 104-1 and 104-2 to send a Transfer_Ready frame, the first MPU 101 further refers to a transfer detecting signal output by the signal output module 111 in the channel controller 102 to check whether it is the timing at which the DMA controller 106 is transferring data. When the transfer detecting signal indicates the timing at which the DMA controller 106 is transferring data for writing process from the DRAM 150, the first MPU 101 inhibits a request of sending a Transfer_Ready frame.

The channel controller 102 assigns physical addresses of write destinations, while updating channels in a round-robin fashion, in response to write commands issued from the first MPU 101, as long as there are valid physical addresses provided for writing user data. The channel controller 102 then accumulates write commands in a write command queue (not illustrated) in the channel controller 102. When assigning physical addresses, the channel controller 102 excludes channels specified as defective.

Once the write commands for all channels are accumulated, the channel controller 102 carries out a preparation for all channel synchronous writing in the following procedure.

The channel controller 102 first stops issuing new commands to the NAND memory controllers 107-1 to 107-8. The channel controller 102 then waits until the NAND memory controllers 107-1 to 107-8 complete all commands in execution.

Once the NAND memory controllers 107-1 to 107-8 on all channels complete the command execution, the channel controller 102 sets a type of writing to be carried out (for example, user data writing, or writing by compaction) to the shared RAM 108. For example, for a user data write command issued from the first MPU 101, the channel controller 102 sets “user data writing” to the shared RAM 108. The information indicative of a type of writing set is referred to by the first MPU 101.

In a non-volatile memory such as a NAND memory, a unit of writing and a unit of erasing are different from each other. Therefore, in the non-volatile memory, even when writing by updating is carried out, invalid old data remains in a unit of writing. In a unit of erasing constituted by a plurality of units of writing, not only the invalid data, but also valid data are present. To enable new writing, it is necessary to reuse a unit of erasing with less valid data by gathering only the valid data remaining in the unit of erasing and by copying all the valid data to a unit of writing provided in a separate area. Such process is referred to as compaction. In the semiconductor disk device 1 in the present embodiment, even when such compaction is carried out, it is controlled such that a non-transfer period does not arise.

With the channel controller 102 instructing the DMA controller 106 to transfer data for writing serving as a trigger, the signal output module 111 then starts outputting a transfer detecting signal (for example, 1) indicative of the fact that the DMA controller 106 is carrying out data transfer. The first MPU 101 then refers to the transfer detecting signal, thereby recognizing whether the DMA controller 106 is carrying out data transfer for all channel simultaneous writing.

After the above-described preparation is completed, the channel controller 102 issues the write commands accumulated in the write command queue altogether in sequence from the beginning to the NAND memory controllers 107-1 to 107-8 on respective channels. Consequently, a writing process with all channels synchronized is started. At the same time, the channel controller 102 instructs the DMA controller 106 to read out data to be the subject of a write command for each channel from the DRAM 150.

After the all channel simultaneous transfer is executed, once the transfer of total transfer bytes, which is set by the channel controller 102, to the NAND memory controllers 107-1 to 107-8 on all channels is completed, the DMA controller 106 notifies the channel controller 102 of the completion of the transfer. Consequently, the signal output module 111 switches from the transfer detecting signal (for example, 1) indicative of the fact that the DMA controller 106 is transferring data for writing process to a transfer detecting signal (for example, 0) indicative of the fact that the DMA controller 106 is not transferring data.

When all of the user data to write simultaneously on all channels are stored in the DRAM 150, the writable amount of data in the shared RAM 108 becomes 0. Accordingly, the first MPU 101 cannot commit a new sending of data to the host. Therefore, the first MPU 101 waits until the writable amount of data in the shared RAM 108 is updated by the second MPU 103 to a value other than 0.

In the meantime, the transfer of data for all channel simultaneous writing by the DMA controller 106 is started. At this timing, the second MPU 103 provides physical addresses used for the subsequent round of writing to the channel controller 102, and sets the writable amount of data in the subsequent round of all channel simultaneous writing to the shared RAM 108.

As described in the foregoing, after the transfer for simultaneous writing on all channels is started, the writable amount of data in the shared RAM 108 is updated by the second MPU 103 at an early timing. However, at the time of update, because the DMA controller 106 is in the middle of data transfer (because the signal output module 111 outputs the transfer detecting signal of 1), the first MPU 101 cannot commit a new sending of data. After the simultaneous transfer of data by the DMA controller 106 is completed (after the transfer detecting signal output from the signal output module 111 is switched to 0), the first MPU 101 can then request the SAS controllers 104-1 and 104-2 to send a Transfer_Ready frame.

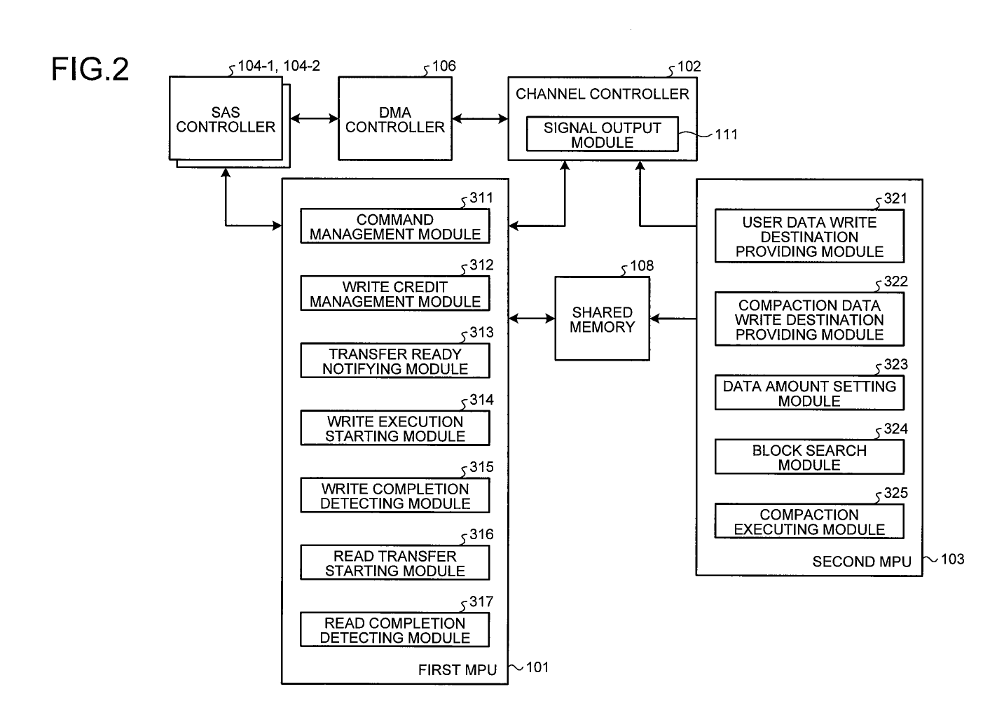

FIG. 2 is a block diagram schematically illustrating a software configuration of the first MPU 101 and the second MPU 103. As illustrated in FIG. 2, the first MPU 101 comprises a command management module 311, a write credit management module 312, a Transfer_Ready notifying module 313, a write execution starting module 314, a write completion detecting module 315, a read transfer starting module 316, and a read completion detecting module 317.

The second MPU 103 comprises a user data write destination providing module 321, a compaction data write destination providing module 322, a data amount setting module 323, a block search module 324, and a compaction executing module 325.

The command management module 311 determines whether the SAS controllers 104-1 and 104-2 are receiving a command (a read command or a write command) via the bus. When the SAS controllers 104-1 and 104-2 are receiving a command, the command management module 311 retrieves the command and stores the command in a write command queue or a read command queue configured on a memory of the first MPU 101. These command queues also manage an execution sequence of the commands received. The command management module 311 further issues a read command to the channel controller 102 after allocating an area on the DRAM 150 to store data for the read command. However, when an area to store data on the DRAM 150 lacks, the issuing of respective commands is kept waiting. When read commands are accumulated in the read command queue, the command management module 311 issues the read commands to the channel controller 102. This starts the reading of data from the NAND memories 160-1 to 160-8.

When write commands are accumulated in the write command queue, the write credit management module 312 manages areas where the data for the write commands is stored. The write credit management module 312 further refers to the writable amount of data of the shared RAM 108 and the transfer detecting signal output from the signal output module 111 of the channel controller 102, and determines whether the data can be received (whether a Transfer_Ready frame can be sent).

When sending a Transfer_Ready frame is determined possible by the write credit management module 312, the Transfer_Ready notifying module 313 requests the SAS controllers 104-1 and 104-2 for notification of Transfer_Ready frame specifying a receivable amount of data. Here, the Transfer_Ready notifying module 313 sets a receivable amount of data and an address possible to store in the DRAM 150 to the SAS controllers 104-1 and 104-2. The Transfer_Ready notifying module 313 then makes the SAS controllers 104-1 and 104-2 execute the sending of the Transfer_Ready frame and the receiving of the data associated with the frame.

The write execution starting module 314 polls the completion of process of storing data sent from the host to the DRAM 150 via the DMA controller 106. When the completion of storage of the data necessary for all channel simultaneous writing to the DRAM 150 is detected, the write execution starting module 314 issues to the channel controller 102 a write command equivalent to the amount of data transfer contained in the Transfer_Ready frame having requested the sending of the data, together with the address of the DRAM 150 where the data is stored. The write commands are accumulated once in the write command queue in the channel controller 102. Once a number of commands equivalent to a given writing amount of data necessary for simultaneous writing with all channels synchronized are accumulated in the write command queue, the channel controller 102 transfers the commands to the NAND memory controllers 107-1 to 107-8.

Furthermore, the write execution starting module 314 subtracts the amount of data written by the issued write commands from the writable amount of data stored in the shared RAM 108.

The write completion detecting module 315 detects the completion of write commands transferred altogether to the NAND memory controllers 107-1 to 107-8. In the present embodiment, the NAND memory controllers 107-1 to 107-8 accumulate completion statuses of write commands to internal FIFO buffers not illustrated. The write completion detecting module 315 polls those statuses to detect the completion of write commands. The write completion detecting module 315 then releases a buffer area on the DRAM 150 where the data of the completed write commands has been assigned.

The read transfer starting module 316 detects the completion of reading data from the NAND memories 160-1 to 160-8 that is started by the command management module 311. The NAND memory controllers 107-1 to 107-8 accumulate completion statuses of read commands in the internal FIFO buffers not illustrated. The read transfer starting module 316 then polls those statuses to detect the completion of read commands. The read transfer starting module 316 then requests the SAS controllers 104-1 and 104-2 to transfer the data stored on the DRAM 150 by the read commands to the host. This starts the transfer of the read data to the host.

The read completion detecting module 317 polls the SAS controllers 104-1 and 104-2 to detect the completion of transfer to the host. When the completion of transfer is detected, the read completion detecting module 317 releases a buffer area on the DRAM 150 where the data for the transfer has been assigned.

In the first MPU 101 in the present embodiment, the processes of the respective constituent modules are repeated in the order of the command management module 311, the write credit management module 312, the Transfer_Ready notifying module 313, the write execution starting module 314, the write completion detecting module 315, the read transfer starting module 316, and the read completion detecting module 317.

The configuration of the second MPU 103 will be described. The user data write destination providing module 321 polls the channel controller 102 to detect a start of simultaneous writing with all channels synchronized. When the start is detected, the user data write destination providing module 321 provides new addresses of the NAND memories 160-1 to 160-8 that are subsequent write destinations to the channel controller 102. The new addresses of the NAND memories 160-1 to 160-8 use free blocks provided by the compaction executing module 325.

The compaction data write destination providing module 322 polls the channel controller 102 to detect a start of compaction write. The compaction data write destination providing module 322 provides new addresses of the NAND memories 160-1 to 160-8 that are subsequent write destinations by compaction to the channel controller 102. The new addresses of the NAND memories 160-1 to 160-8 use free blocks provided by the compaction executing module 325.

The data amount setting module 323 sets to the shared RAM 108 information indicative of a writable amount of data at one time with all channels synchronized. The simultaneous writing may be a writing of user data or compaction write. The setting by the data amount setting module 323 is carried out with the detection of simultaneous starts by the user data write destination providing module 321 or the detection of a start of compaction write by the compaction data write destination providing module 322 as a trigger.

The block search module 324 searches blocks to be the subject of compaction from a block management table stored in the DRAM 150. Although the explanation of an algorithm used for selection is omitted because various methods have been proposed, the block search module 324 generally selects blocks containing small amounts of valid data.

The compaction executing module 325 executes compaction. The compaction executing module 325 issues to the channel controller 102 a read command that reads out a page containing valid data of a block selected by the block search module 324 to a data storage area of the DRAM 150. Thereafter, the compaction executing module 325 detects the completion of read out to the DRAM 150 by polling. When it is detected, the compaction executing module 325 issues to the channel controller 102 a write command to copy the data stored in the DRAM 150 to a moving destination.

The move of a plurality of blocks by the compaction executing module 325 produces free blocks, and these blocks are the very free blocks that the user data write destination providing module 321 and the compaction data write destination providing module 322 provide.

In the second MPU 103, the processes by the above-described constituents are executed by time sharing. Therefore, the above-described compaction process is not executed collectively.

The semiconductor disk device 1 in the present embodiment comprises the shared RAM 108 that stores therein a writable amount of data for all channel simultaneous writing at one time, and the signal output module 111 of the channel controller 102 that outputs a transfer detecting signal indicative of whether the DMA controller 106 is carrying out data transfer for simultaneous writing on all channels.

In other words, the first MPU 101 is arranged to control so that it receives data from the host according to a writable amount of data in the shared RAM 108 and stores the data in the DRAM 150. Accordingly, only the data of a writable amount in all channel simultaneous writing is stored in the DRAM 150, and the receiving of any more data is inhibited. Consequently, during preparation for all channel simultaneous writing, the sending of data from the host is inhibited.

Moreover, the signal output module 111 is arranged to output a transfer detecting signal indicative of being in all channel simultaneous writing. While the data transfer for all channel simultaneous writing is carried out, the first MPU 101 then inhibits the receiving of data from the host regardless of a writable amount of data set in the shared RAM 108.

By the combination of these processes, no data is received from the host while the process for all channel simultaneous writing is carried out. This allows the reading of data from the DRAM 150 for all channel simultaneous writing and the writing of data received from the host to the DRAM 150 in the DMA controller 106 to be prevented from conflicting with each other. The specific timings of data transfers will be described next.

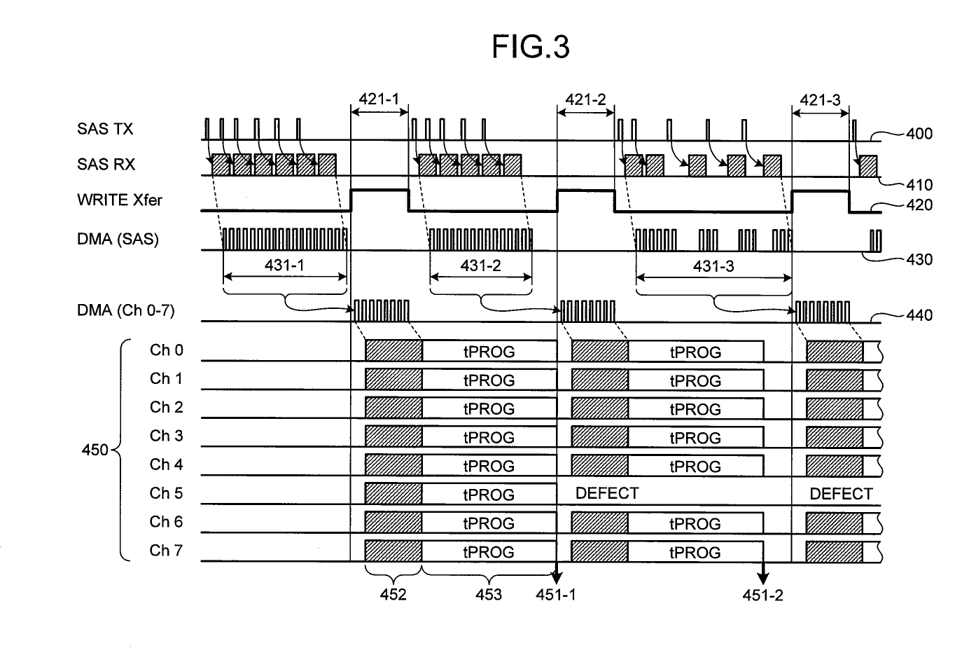

FIG. 3 is a timing chart illustrating transfer timings of sequential write in the semiconductor disk device 1 in the present embodiment. SAS TX 400 in FIG. 3 represents the timing of the semiconductor disk device 1 sending a Transfer_Ready frame to the host. SAS RX 410 represents the timing of the semiconductor disk device 1 receiving user data from the host.

Write Xfer 420 represents the timing of a transfer detecting signal that the signal output module 111 outputs. DMA (SAS) 430 represents the timing of the DMA controller 106 transferring data received by the SAS controllers 104-1 and 104-2 to the DRAM 150. DMA (Ch 0-7) 440 represents the timing of the DMA controller 106 transferring data stored in the DRAM 150 to the NAND memory controllers 107-1 to 107-8.

Data transfer timings 450 represent the timings of the NAND memory controllers 107-1 to 107-8 transferring data to the NAND memories 160-1 to 160-8. The data transfer timings 450 are composed of timings 452 of the NAND memory controllers 107-1 to 107-8 transferring user data to the NAND memories 160-1 to 160-8 and timings 453 of the NAND memories 160-1 to 160-8 writing the user data.

As illustrated in FIG. 3, the SAS controllers 104-1 and 104-2 receive user data from the host in response to the sending of a Transfer_Ready frame. Although the received user data is temporarily stored in the FIFO buffers 105-1 to 105-4, the DMA controller 106 transfers the received user data to the DRAM 150 during transfer periods of 431-1, 431-2, and 431-3.

After the data for all channel simultaneous writing is accumulated in the DRAM 150 and the writing to the NAND memories 160-1 to 160-8 is completed (for example, the timing 451-1), the DMA controller 106 transfers the user data to the NAND memory controllers 107-1 to 107-8 according to instructions of the channel controller 102 (the transfer timing 440). At that time, the signal output module 111 outputs a transfer detecting signal indicative of the fact that the DMA controller 106 is carrying out data transfers for all channel simultaneous writing (refer to time periods 421-1, 421-2, and 421-3).

In the example illustrated in FIG. 3, the amount of data written at one time when there is no defect present matches the amount of data transferred by the DMA controller 106 in the transfer period 431-1. In contrast, the amount of data written at one time when there is a defect present matches the amount of data transferred by the DMA controller 106 in the transfer period 431-2. In the present embodiment, accurate receiving of data with the amount of data of the subsequent writing from the host becomes possible and thus, the process of writing simultaneously with all channels synchronized can be easily realized. In other words, in the semiconductor disk device 1 in the present embodiment, a Transfer_Ready frame is not sent to the host immediately before the process of writing simultaneously with all channels synchronized. Consequently, the receiving of user data from the host immediately before an all channel synchronous transfer can be inhibited.

Furthermore, in the semiconductor disk device 1 in the present embodiment, even at the timing of all channel simultaneous writing being completed (for example, a timing 451-2), when an amount of data for all channel simultaneous writing is not stored in the DRAM 150, the DMA controller 106 waits until the amount of data for the simultaneous writing is stored in the DRAM 150. After the amount of data is stored, the DMA controller 106 then transfers user data to the NAND memory controllers 107-1 to 107-8 according to the instructions of the channel controller 102.

While the signal output module 111 outputs a transfer detecting signal of 1 indicative of the fact that data is being transferred, the data amount setting module 323 of the second MPU 103 sets the subsequent writable amount of data to the shared RAM 108.

At the timing of the transfer detecting signal that the signal output module 111 outputs being switched from 1 to 0, the write credit management module 312 of the first MPU 101 determines that the data from the host can be received. Based on the determination, the Transfer_Ready notifying module 313 requests the SAS controllers 104-1 and 104-2 for notification of Transfer_Ready frame.

By carrying out the control in such manner, as illustrated in FIG. 3, in the DMA controller 106, the reading of data from the DRAM 150 and the writing of data to the DRAM 150 can be prevented from conflicting with each other. This enables such a control that a non-transfer period does not arise.

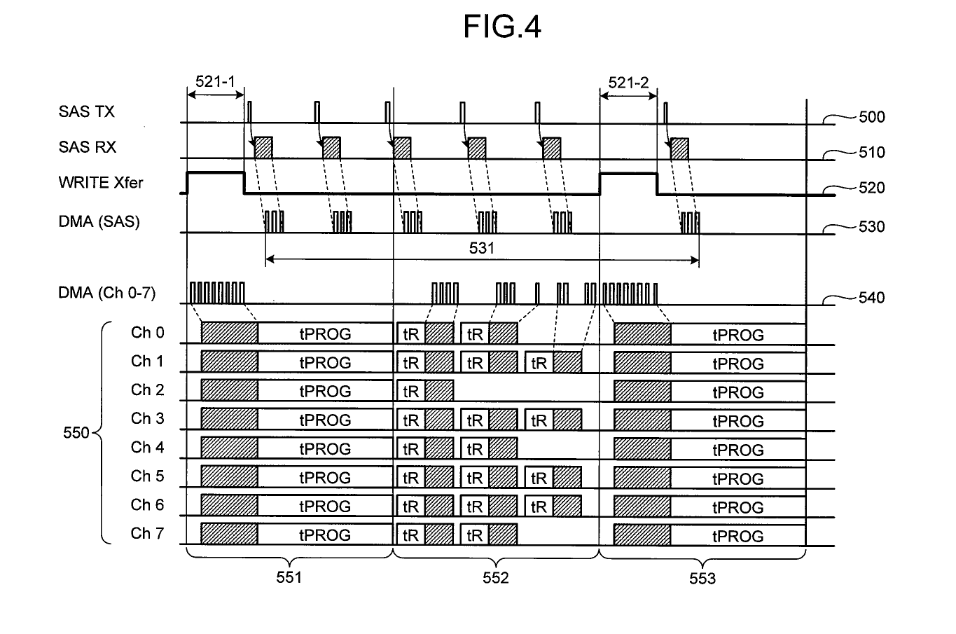

FIG. 4 is a timing chart illustrating transfer timings of random write in the semiconductor disk device 1 in the present embodiment. SAS TX 500 in FIG. 4 represents the timing of the semiconductor disk device 1 sending a Transfer_Ready frame to the host. SAS RX 510 represents the timing of the semiconductor disk device 1 receiving user data from the host.

Write Xfer 520 represents the timing of a transfer detecting signal that the signal output module 111 outputs. DMA (SAS) 530 represents the timing of the DMA controller 106 transferring data received by the SAS controllers 104-1 and 104-2 to the DRAM 150. DMA (Ch 0-7) 540 represents the timing of the DMA controller 106 transferring data stored in the DRAM 150 to the NAND memory controllers 107-1 to 107-8.

Data transfer timings 550 represent the timings of the NAND memory controllers 107-1 to 107-8 transferring data to the NAND memories 160-1 to 160-8. The data transfer timings 550 are composed of a time period 551 in which the NAND memory controllers 107-1 to 107-8 write user data to the NAND memories 160-1 to 160-8, a time period 552 in which the NAND memory controllers 107-1 to 107-8 read out data from the NAND memories 160-1 to 160-8 to the DRAM 150 for compaction, and a time period 553 in which the NAND memory controllers 107-1 to 107-8 write the data held in the DRAM 150 to the NAND memories 160-1 to 160-8 for compaction.

In the semiconductor disk device 1, carrying out random writes causes invalid data at random physical locations. Therefore, compaction becomes necessary to enable writing of new data. The compaction is generally executed while the command is not processed, to prevent the deterioration of performance. However, during the period in which write commands are issued frequently, areas for new writings must be allocated keeping up with such a pace. Accordingly, as illustrated in FIG. 4, the compaction needs to be carried out in parallel with the receiving of user data.

In random write, for writing user data at one time (time period 551), a number of compaction processes (time periods 552, 553) are required. The time period 552 is a time period where the data of compaction source is read out to a buffer for compaction allocated in the DRAM 150. The time period 553 is a time period where the data stored on the DRAM 150 is written to a compaction destination. The compaction is a process to move valid data collectively. The writing process in compaction (a process carried out in the time period 553) is the same as the process of writing user data and thus, in a time period 521-2 where all channel simultaneous transfer for compaction is executed, it is necessary to inhibit the receiving of data from the host.

Even while the compaction is executed, write commands are issued from the host. In contrast, in the semiconductor disk device 1 in the present embodiment, during the time period in which the Write Xfer 520 of 1 is output, regardless of the writing of user data or writing back by compaction, the control can be made not to output any commitments by Transfer_Ready frame to the host. As a consequence, in the transfer period 521-2 for writing back by compaction, the overlapping probability of data transfer from the host can be kept low.

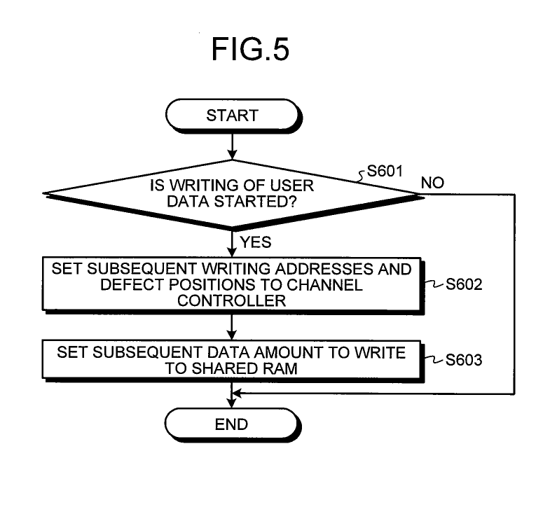

The process for carrying out all channel simultaneous writing by the second MPU 103 will be described. FIG. 5 is a flowchart illustrating a procedure of the above-described process in the second MPU 103 in the present embodiment. While the example illustrated in FIG. 5 is the process for writing user data, the same process is carried out even for compaction.

The user data write destination providing module 321 of the second MPU 103 first polls the channel controller 102, and determines whether simultaneous writing with all channels synchronized is started (S601). When the simultaneous writing is not started (No at S601), the process is finished.

When the simultaneous writing is started (Yes at 5601), the user data write destination providing module 321 then sets subsequent writing addresses and defect positions to the channel controller 102 (S602).

Thereafter, the data amount setting module 323 of the second MPU 103 sets an amount of data to write in the subsequent simultaneous writing process to the shared RAM 108 (S603). The amount of data varies depending on the presence of defects and such.

By the above-described procedure, the settings necessary for the subsequent all channel simultaneous writing can be carried out. The processing procedure above is carried out regularly at a given time interval by the second MPU 103.

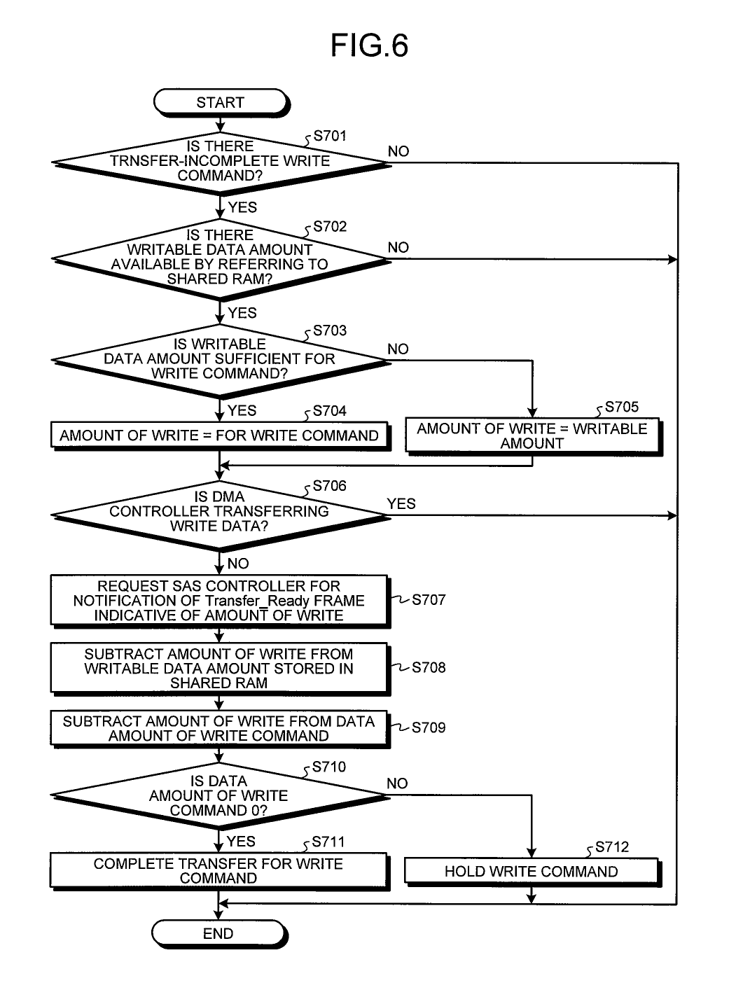

The process for executing a write command by the first MPU 101 will be described next. FIG. 6 is a flowchart illustrating a procedure of the above-described process in the first MPU 101 in the present embodiment. While the example illustrated in FIG. 6 is the process for writing user data, the same process is carried out even for compaction.

The write credit management module 312 first refers to the write command queue, and determines whether there is a write command of incomplete transfer present (S701). When there is no write command present (No at S701), the process is finished.

On the other hand, when there is a write command of incomplete transfer present (Yes at 5701), the write credit management module 312 refers to the shared RAM 108, and determines whether a writable amount of data is available (S702). When the writable amount of data is not available (No at 5702), the process is finished.

When a writable amount of data is available (Yes at S702), the write credit management module 312 then determines whether the amount of data that the write command requires can be written in the writable amount of data (S703). When it can be written (Yes at 5703), the write credit management module 312 sets the amount of data that the write command requires as an amount of data to write in the subsequent all channel simultaneous writing process (S704). Meanwhile, when it cannot be written (No at 5703), the write credit management module 312 sets the writable amount of data stored in the shared RAM 108 as the amount of data to write in the subsequent all channel simultaneous writing (S705).

Thereafter, the write credit management module 312 determines, based on a transfer detecting signal that the signal output module 111 outputs, whether the DMA controller 106 is transferring data for writing to the NAND memories 160-1 to 160-8 (S706). When it is transferring (Yes at S706), the process is finished.

In contrast, when the write credit management module 312 determines that the DMA controller 106 is not transferring (No at S706), it is assumed that data can be received and thus, the Transfer_Ready notifying module 313 requests to the SAS controllers 104-1 and 104-2 notification of a Transfer_Ready frame indicating an amount to write (S707). Accordingly, the SAS controllers 104-1 and 104-2 notify the host of the Transfer_Ready frame.

The write execution starting module 314 then subtracts the amount of data to write by the issued write command from the writable amount of data stored in the shared RAM 108 (S708).

The write execution starting module 314 then subtracts the amount of data to write by the process of this time round from the amount of data to write by the write command (S709).

The write execution starting module 314 then determines whether the amount of data to write by the write command is reduced to 0 (S710). When it is not reduced to 0 (No at S710), the write execution starting module 314 holds the write command in the write command queue (S712), and the process is then finished.

Meanwhile, when the amount of data to write by the write command is reduced to 0 (Yes at S710), the write execution starting module 314 deletes the write command from the write command queue assuming that the transfer by the write command is finished (S711), and the process is finished.

By the above-described processing procedure, a Transfer_Ready frame is sent at a timing other than the timing in which the DMA controller 106 is transferring data. The above-described processing procedure is carried out regularly at a given time interval by the first MPU 101.

As in the foregoing, in the present embodiment, the data amount setting module 323 of the second MPU 103 sets the writable amount of data for all channel simultaneous writing at one time to the shared RAM 108. The write execution starting module 314 of the first MPU 101 then subtracts, each time a writing process is carried out, the amount of data written in the writing process from the writable amount of data set in the shared RAM 108. The SAS controllers 104-1 and 104-2 then receive data from the host until the writable amount of data is reduced to 0. When the writable amount of data is reduced to 0, the receiving of data from the host is inhibited. At the start of an all channel simultaneous writing process, the data amount setting module 323 then sets a writable amount of data in the subsequent all channel simultaneous writing process to the shared RAM 108 again.

In the semiconductor disk device 1 in the present embodiment, all channel synchronous transfer of user data and data transfer from the host are prevented from conflicting with each other. Furthermore, even in a time period of all channel synchronous transfer by compaction write, the issuing of a new Transfer_Ready frame can be inhibited.

Consequently, in the semiconductor disk device 1 in the present embodiment, a bus freeze in the shared bus interface with SAS or FC used can be prevented. Here, in the semiconductor disk device 1, even when buffer memories of a small capacity or of a low-speed are used between the DMA controller 106 and the NAND memory controllers 107-1 to 107-8, the deterioration of performance can be prevented.

In the semiconductor disk device 1 in the present embodiment, the total amount of data received from the host and stored in the DRAM 150 matches a writable amount of data for the subsequent all channel simultaneous writing process at one time. To realize this, the issuing of a Transfer_Ready frame is controlled based on a writable amount of data stored in the shared RAM 108. Accordingly, an amount of data that can be written in a writing process at one time only is committed.

Furthermore, in the semiconductor disk device 1 in the present embodiment, while the DMA controller 106 is simultaneously transferring for all channel simultaneous writing, new committing by a Transfer_Ready frame to the host is restricted.

Consequently, with the semiconductor disk device 1 in the present embodiment, even when the interface is of SAS or of FC that shares a bus with a plurality of devices, the transfer efficiency can be improved to a maximum extent without using expensive fast buffer memories. Moreover, the performance of the overall system sharing the bus can be enhanced.

As in the foregoing, with the semiconductor disk device 1 in the present embodiment, it is possible to reduce conflicts between host transfer and all channel simultaneous transfer for writing back of compaction that is started asynchronously. As a consequence, a bus freeze can be prevented, and the performance of the overall system can be enhanced.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile memory;
a storage configured to store therein data temporarily;
a notifying module configured to notify a host of data transfer permission with a specified amount of data to be written in the storage;
a transfer module configured to transfer data transferred from the host according to the data transfer permission to the storage, and to transfer the data stored in the storage to be written to the non-volatile memory; and
a controller configured to inhibit notification of the data transfer permission by the notifying module until transfer of the data to the non-volatile memory by the transfer module is completed after an amount of data necessary to be written in the non-volatile memory is stored in the storage.

2. The memory system of claim 1, wherein the transfer module is configured to transfer data subject to compaction only for the amount of data from the non-volatile memory to the storage, and to transfer data subject to the compaction transferred to the storage to the non-volatile memory collectively.

3. The memory system of claim 1, wherein
the non-volatile memory comprises a plurality of non-volatile memories, and
the notifying module is configured to notify the host of the data transfer permission until a specific amount of data necessary to synchronize a plurality of channels respectively corresponding to the non-volatile memories to transfer is stored in the storage, and
the transfer module is configured to synchronize the channels to transfer data transferred from the host to the non-volatile memories when the data transferred from the host is stored in the storage for the specific amount of data.

4. The memory system of claim 1, wherein
the non-volatile memory comprises a plurality of non-volatile memories, and
the memory system further comprises a setting module configured to set data amount information indicative of a writable amount of data with a plurality of channels respectively corresponding to the non-volatile memories synchronized at one time to a shared storage that is referable by the controller, and
the controller is configured to inhibit the notification of the data transfer permission when the storage stores therein data of the amount of data indicated by the data amount information stored in the shared storage.

5. The memory system of claim 1, wherein the serial attached SCSI (SAS) or the fiber channel is used as an interface connecting to the host.

6. A data control method performed in a memory system, the memory system comprising a non-volatile memory, and a storage configured to store therein data temporarily, the data control method comprising:
notifying, by a notifying module, to notify a host of data transfer permission with a specified amount of data to be written in the storage;
transferring, by a transfer module, to transfer data transferred from the host according to the data transfer permission to the storage, and to transfer the data stored in the storage to be written to the non-volatile memory; and
controlling, by a controller, to inhibit notification of the data transfer permission at the notifying until transfer of the data to the non-volatile memory at the transferring is completed after an amount of data necessary to be written in the non-volatile memory is stored in the storage.

7. A data controller comprising:
a notifying module configured to notify a host of data transfer permission with a specified amount of data to be written in a storage;
a transfer module configured to transfer data transferred from the host according to the data transfer permission to the storage, and to transfer the data stored in the storage to be written to a non-volatile memory; and
a controller configured to inhibit notification of the data transfer permission by the notifying module until transfer of the data to the non-volatile memory by the transfer module is completed after an amount of data necessary to be written in the non-volatile memory is stored in the storage.
